(19) United States
(12) Patent Application Publication
(10) Pub. No.: US 2024/0298244 A1
(43) Pub. Date: Sep. 5, 2024

(54) A METHOD OF CONNECTING A MESH NODE TO A MESH COMMUNICATION NETWORK

(71) Applicant: Telefonaktiebolaget LM Ericsson (publ), Stockholm (SE)

(72) Inventors: Thomas Rimhagen, LINKÖPING (SE); Per Skillermark, ÅRSTA (SE)

(21) Appl. No.: 18/573,399

(22) PCT Filed: Jul. 7, 2021
(86) PCT No.: PCT/EP2021/068901

§ 371 Date: Dec. 21, 2023

(51) Int. Cl. H04W 40/24; H04W 76/10; H04W 84/18

(52) U.S. Cl. CPC H04W 40/246; H04W 76/10; H04W 84/18

(57) ABSTRACT

A method of connecting a mesh node to a mesh communication network comprising a plurality of interconnected mesh nodes, wherein said mesh node is arranged to connect to said mesh communication network using a default physical layer, PHY, and is arranged to connect to said mesh communication network using a long-range PHY, wherein a reach area of said long-range PHY is greater than a reach area of said default PHY, said method comprises the steps of determining, by said mesh node, that said long-range PHY is required for connecting to said mesh communication network, broadcasting, by said mesh node, a long-range support message using said long-range PHY thereby requesting connection to said mesh communication network, receiving, by said mesh node, from a mesh node in said mesh communication network, a support response of said long-range support message thereby indicating support of said connection of said mesh node to said communication network using said long-range PHY.

### TECHNICAL FIELD

The present disclosure is directed to connecting a mesh node to a mesh communication network and, more specifically, to connecting a mesh node to the mesh communication network whenever the mesh node is out of a particular range of said mesh communication network.

### BACKGROUND

Mesh communication networks uses multi-hop technologies to extend coverage and create connectivity between nodes that cannot communicate directly with each other. In Bluetooth mesh, for example, managed flooding is used to forward messages over either a connection-less advertising bearer or a connection-oriented GATT bearer. The advertising bearer utilizes legacy advertising, which is transmitted over three primary advertising channels. Both bearers use a fixed over-the-air data rate of 1 Mbps.

Bluetooth Mesh nodes periodically send out beacons, so called secure network beacons, to identify the sub-net and its security state. The frequency of the beacon transmissions is regulated such that, on average, every node should receive a beacon for a given sub-net every ten seconds. For a node the absence of received secure network beacons is an indication that it is not within range of any other node in the sub-net, and may not be able to communicate with other nodes in the network.

Bluetooth Mesh also supports heartbeat messages. heartbeat messages are sent/published by a node to let other nodes determine the topology of a sub-net. Not receiving any heartbeat message, from a node that is expected to publish heartbeat messages, indicates that there is no path, or no connectivity, between the node publishing the heartbeat message and the other node.

The Extended Advertising feature was released in the Bluetooth Core Specification version 5.0. This enables a message size up to 1650 bytes. At the same time, support for additional data rates of 125 kbps, 500 kbps, and 2 Mbps, in addition to the already available 1 Mbps rate, were introduced. These rates can be used both for advertising and connections. In the future, this might be complemented by even higher data rates, like 4 Mbps and 6 Mbps, and perhaps also even lower rates.

One of the downsides of current mesh communication networks is that it is not always possible for a mesh node to connect to a mesh communication network comprising a plurality of interconnected mesh nodes.

### SUMMARY

It is an object of the present disclosure to provide for a method of connecting a mesh node to a mesh communication network comprising a plurality of interconnected mesh nodes. It is a further object of the present disclosure to provide for associated methods as well as a computer program.

In a first aspect of the present disclosure, there is provided method of connecting a mesh node to a mesh communication network comprising a plurality of interconnected mesh nodes, wherein said mesh node is arranged to connect to said mesh communication network using a default physical layer, PHY, and is arranged to connect to said mesh communication network using a long-range PHY, wherein a reach area of said long-range PHY is greater than a reach area of said default PHY, said method comprises the steps of:
determining, by said mesh node, that said long-range PHY is required for connecting to said mesh communication network;
broadcasting, by said mesh node, a long-range support message using said long-range PHY thereby requesting connection to said mesh communication network;
receiving, by said mesh node, from a second mesh node in said mesh communication network, an support response of said long-range support message thereby indicating support of said connection of said mesh node to said communication network using said long-range PHY.

The inventors have found a method to increase the probability that a particular mesh node is able to connect to a mesh communication network. The inventors have realized that a mesh node may request a connection to the mesh communication network using a long-range PHY, i.e. a PHY that is tailored to provide for a long range. This enables the distance between the transmitter and receiver to be larger compared to conventional PHY's.

If, for example, the Bluetooth mesh communication network is extended with support for long-range PHY and an Extended Advertising mesh bearer, one may utilize a mechanism that appropriately determines which rate(s) that should be utilized by the transmitting nodes in a network. In this disclosure, we address, amongst other, the problem of appropriately using a long-range, low-rate PHY with a data rate below a default Bluetooth Mesh rate of 1 Mbps. A low rate, like 125 kbps, is helpful to create a connection between mesh nodes in situations with poor coverage. However, as the data rate is low and the time-on-air is long, the low rates should only be used when really needed.

One situation in which such a mechanism may be desired is when deploying a new mesh node in the outskirts of a mesh communication network, for example a garden light that must communicate with indoor mesh nodes. If the mesh node is not able to reach any mesh node in the mesh communication network using the default PHY, i.e. the default 1 Mbps rate, it may need to use a long-range PHY, for example a lower rate to create a connection to mesh nodes in the mesh communication network.

Another situation is when the topology in the mesh communication network changes, for example due to one or several mesh relay nodes going out of operation. This type of topology change may disconnect different parts of the mesh communication network from each other, but if some nodes starts communicating using a long-range PHY, for example a lower rate (with longer range), it may be possible to create a connection between mesh nodes in the different mesh communication network parts and re-establish network connectivity.

In essence, the present disclosure is directed to three steps. The first step is determining by a non-connected mesh node that a long-range PHY is required for connecting to the mesh communication network. The non-connected mesh node may first try conventional methods, using a conventional or default PHY, for connecting to the mesh communication network. Once such conventional methods do not succeed, the non-connected mesh node may proceed and try a long-range PHY. As such, the non-connected mesh node may broadcast a long-range support message using the long-range PHY thereby requesting connecting to the mesh communication network. In other words, the non-connected mesh node requests mesh nodes in its vicinity to setup a long-range bearer. Finally, the long-range bearer is used for connecting to the mesh communication network.

In accordance with the present disclosure, the mesh communication network comprises a plurality of interconnected mesh nodes, including the above identified second mesh node. The second mesh node is thus a part of the mesh communication network.

In the mesh communication network, a mesh node may periodically send out beacons which are, for example, called secure network beacons to identify the sub-net and the security state. Every node in the mesh communication network, including the so-identified second mesh node, may receive such beacons. The mesh communication network may thus be defined by the plurality of interconnected nodes in a same sub-net, i.e. nodes that are able to receive beacons from one another. In accordance with the present disclosure, the so-identified second mesh node belongs to the mesh communication network.

In an example, the mesh node receives a plurality of support responses of said long-range support message from a plurality of mesh nodes in said mesh communication network, and wherein said method further comprises the steps of:
selecting, by said mesh node, one of said plurality of mesh nodes in said mesh communication network from which said mesh node receives said plurality of support responses of said long-range support message, for connecting said mesh node to said mesh communication network.

It is noted that multiple mesh nodes in the mesh communication network may receive the particular broadcasted long-range support message. In that case, also those multiple mesh nodes may provide a support response of long-range support back to the requesting mesh node. The non-connected mesh node, i.e. the requesting mesh node, may then select one of the multiple mesh nodes for use as the connection point to the mesh communication network.

The requesting mesh node may thus select one of the multiple mesh nodes for use as the connection point to the mesh communication network. In order to do so, the requesting mesh node may transmit an acknowledgement to the selected mesh node for making the selected mesh node aware that it is the selected mesh node for providing long range support.

Once the connection between the mesh node and the mesh communication network is established, via the selected mesh node in the mesh communication network, the mesh node is considered to be connected to the mesh communication network.

In an example, messages sent using said long-range PHY have a lower rate compared to messages sent using said default PHY.

By sending a message with a lower rate, the range of the message may be extended. A lower rate may, for example, be a lower QAM constellation that is used, or anything alike.

In a further example, the step of determining comprises any of:
determining, by said mesh node, that said mesh node is out of reach of said mesh communication network by detecting absence of receipt of messages from said mesh communication network.

The mesh node may, for example, determine the need for long-range support by monitoring received secure network beacons and mesh message, and optionally heartbeat message.

The absence of secure network beacons and mesh messages may indicate that the mesh node is not within range of any other mesh node in the sub-net of the mesh communication network and that the mesh node may request communication over a long-range bearer, i.e. using a long-range PHY.

Reception of secure network beacons and mesh messages may not, however, guarantee that a sub-net of a mesh communication network is connected, i.e., that there is a path from the mesh node to any other mesh node in the sub-net of the mesh communication network. In a setup where mesh nodes expect to receive heartbeat messages, or similar, from a central mesh node in the mesh communication network but does not receive any such heartbeats, the mesh node may interpret this as an indication of that enhanced communication support is required, i.e. having long-range support.

In a further example, the mesh node is arranged to establish a default bearer using said default PHY, and is arranged to establish a long-range bearer using said long-range PHY, said method further comprises the step of:
establishing, by said mesh node, said long-range bearer to said mesh node in said mesh communication network using said long-range PHY.

A bearer is used to transport data between end points. In this particular case a bearer may be set up between the mesh node requesting connection to the mesh communication network and the mesh node in the mesh communication network that supports the long-range bearer. The bearer is set up using the long-range PHY.

In a further example, said mesh communication network is a Bluetooth Mesh communication network, and wherein said mesh nodes are Bluetooth Mesh nodes.

In yet another example, the mesh node is arranged to establish a long-range bearer using said long-range PHY, wherein said long-range bearer is any of:
a connection-less advertising bearer;
a connection-oriented GATT bearer;
a connection-less advertising bearer between a low-power node and an associated friend mesh node.

The GATT Bearer allows a device that does not support an advertising bearer to communicate with mesh nodes of the mesh communication network, using a protocol known as the Proxy Protocol. A mesh node that relays mesh messages between mesh nodes which use the advertising bearer and mesh nodes which use the GATT Bearer is known as a Proxy Node. The proxy node may support the GATT Bearer and may establish a connection with the mesh node that just supports the GATT Bearer. After connection is established between the proxy node and the device that has a GATT Bearer, the proxy node may expose its mesh proxy service.

Another bearer layer in the Bluetooth mesh communication network is the advertising Bearer. In certain Bluetooth mesh networks, this advertising bearer may make use of Bluetooth GAP advertising and scanning to receive and broadcast messages from other mesh nodes.

In a second aspect of the present disclosure, there is provided a method of supporting connection of a mesh node to a mesh communication network comprising a plurality of interconnected mesh nodes, wherein a mesh node in said mesh communication network is arranged to connect to said mesh node using a default physical layer, PHY, and is arranged to connect to said mesh node using a long-range PHY, wherein a reach area of said long-range PHY is greater than a reach area of said default PHY, said method comprises the steps of:
receiving, from said mesh node, by said mesh node in said mesh communication network, a long-range support message using said long-range PHY thereby requesting connection of said mesh node to said mesh communication network;
transmitting, by said mesh node in said mesh communication network, a support response of said long-range support message thereby indicating support of said connection of said mesh node to said communication network using said long-range PHY.

In a next step, the mesh node in the mesh communication network may receive an acknowledgement from the mesh node that requests connection to the mesh network using a long-range PHY that it would like to use that mesh node for connection to the mesh communication network.

If the mesh node in the mesh communication network does not receive such an acknowledgement it may assume that the requesting mesh node uses another mesh node in the mesh communication network for the long-range connection.

It is noted that advantages of the examples of the different methods with respect to the first aspect of the present disclosure are also applicable to the methods with respect to the second aspect of the present disclosure.

The second aspect of the present disclosure is thus directed to the mesh node in the mesh communication network that receives the long-range support message. In that particular case, the mesh node in the mesh communication network does not need to actively use the long-rage PHY, but is should be arranged to listen on the long-range PHY such that it is capable of receiving that particular long-range support message.

In an example, the messages sent using said long-range PHY have a lower rate compared to messages sent using said default PHY.

It is noted that the present disclosure is not directed to lowering the rate for a particular message for obtaining a long range. The long range may also be obtained by providing a higher transmit power, or using beamforming techniques or the like.

In a further example, the mesh node in said mesh communication network is arranged to establish a default bearer using said default PHY, and is arranged to establish a long-range bearer using said long-range PHY, said method further comprises the step of:
establishing, by said mesh node in said mesh communication network, said long-range bearer to said mesh node using said long-range PHY.

In a further example, the mesh communication network is a Bluetooth Mesh communication network, and wherein said mesh nodes are Bluetooth Mesh nodes.

In yet another example, the mesh node in said mesh communication network is arranged to establish a long-range bearer using said long-range PHY, wherein said long-range bearer is any of:
a connection-less advertising bearer;
a connection-oriented GATT bearer;
a connection-less advertising bearer between a low-power node and an associated friend mesh node.

In a third aspect of the present disclosure, there is provided a mesh node arranged to connect to a mesh communication network comprising a plurality of interconnected mesh nodes, using a default physical layer, PHY, and is arranged to connect to said mesh communication network using a long-range PHY, wherein a reach area of said long-range PHY is greater than a reach area of said default PHY, said mesh node comprising:
process equipment arranged for determining that said long-range PHY is required for connecting to said mesh communication network;
transmit equipment arranged for broadcasting a long-range support message using said long-range PHY thereby requesting connection to said mesh communication network;
receive equipment arranged for receiving from a mesh node in said mesh communication network, a support response of said long-range support message thereby indicating support of said connection of said mesh node to said communication network using said long-range PHY.

As discussed above, the receive equipment may be arranged for receiving a plurality of support responses, from a plurality of mesh nodes in the mesh communication network. As such, the process equipment may be arranged for selecting on of those plurality of mesh nodes as the mesh node through which it would like to connect to the mesh communication network. Such a selection may be based, for example, on received power levels, latency or anything alike. Finally, the transmit equipment may be arranged for transmitting an acknowledgment to the selected mesh node, for making the selected mesh node aware that it would like to use that mesh node as connection to the mesh communication network.

It is noted that the advantages as explained with respect to the examples of the first aspect of the present disclosure are also applicable to the examples of the third aspect of the present disclosure.

In an example, the received equipment is arranged for receiving a plurality of support responses of said long-range support message from a plurality of mesh nodes in said mesh communication network, and wherein said mesh node further comprises:
determine equipment arranged for selecting one of said plurality of mesh nodes in said mesh communication network from which said mesh node receives said plurality of support responses of said long-range support message, for connecting said mesh node to said mesh communication network.

In a further example, the messages sent using said long-range PHY have a lower rate compared to messages sent using said default PHY.

In another example, the process equipment is further arranged for any of:
determining that said mesh node is out of reach of said mesh communication network by detecting that no support responses are received in reply to messages sent using said default PHY;
determining that said mesh node is out of reach of said mesh communication network by detecting absence of receipt of messages from said mesh communication network.

In yet another example, the mesh node is arranged to establish a default bearer using said default PHY, and is arranged to establish a long-range bearer using said long-range PHY, wherein said process equipment is further arranged for:
establishing said long-range bearer to said mesh node in said mesh communication network using said long-range PHY.

In an even further example, the mesh communication network is a Bluetooth Mesh communication network, and wherein said mesh nodes are Bluetooth Mesh nodes.

In another example, the mesh node is arranged to establish a long-range bearer using said long-range PHY, wherein said long-range bearer is any of:
a connection-less advertising bearer;
a connection-oriented GATT bearer;
a connection-less advertising bearer between a low-power node and an associated friend mesh node.

In a fourth aspect of the present disclosure, there is provided a mesh node in a mesh communication network arranged for supporting connection of a mesh node to said mesh communication network comprising a plurality of interconnected mesh nodes, using a default physical layer, PHY, and is arranged to connect to said mesh node using a long-range PHY, wherein a reach area of said long-range PHY is greater than a reach area of said default PHY, said mesh node in said mesh communication network comprising:
receive equipment arranged for receiving, from said mesh node, a long-range support message using said long-range PHY thereby requesting connection of said mesh node to said mesh communication network;
transmit equipment arranged for transmitting, a support response of said long-range support message thereby indicating support of said connection of said mesh node to said communication network using said long-range PHY.

It is noted that the advantages as explained with respect to the examples of the first aspect of the present disclosure are also applicable to the fourth aspect of the present disclosure.

In an example, messages sent using said long-range PHY have a lower rate compared to messages sent using said default PHY.

In a further example, the long-range support message is received with a lower rate compared to messages sent using said default PHY.

In another example, the mesh node in said mesh communication network is arranged to establish a default bearer using said default PHY, and is arranged to establish a long-range bearer using said long-range PHY, said mesh node further comprising:
process equipment arranged for establishing said long-range bearer to said mesh node using said long-range PHY.

In a further example, the mesh communication network is a Bluetooth Mesh communication network, and wherein said mesh nodes are Bluetooth Mesh nodes.

In an example, the mesh node is arranged to establish a long-range bearer using said long-range PHY, wherein said long-range bearer is any of:
a connection-less advertising bearer;
a connection-oriented GATT bearer;
a connection-less advertising bearer between a low-power node and an associated friend mesh node.

In a fifth aspect of the present disclosure, there is provided a computer program product comprising a computer readable medium having instructions stored thereon which, when executed by a mesh node, cause said mesh node to implement a method in accordance with any of the method examples as provided above.

### BRIEF DESCRIPTION OF THE DRAWINGS

FIG. 1 discloses examples of ranges obtained when using different transmission rates in a mesh communication network;

FIG. 2 discloses a schematic view of a mesh node that intends to connect to a mesh communication network;

FIG. 3 discloses a schematic view of a mesh communication network wherein a particular mesh node is broken;

FIG. 4 discloses an example of a method in accordance with the present disclosure.

### DETAILED DESCRIPTION

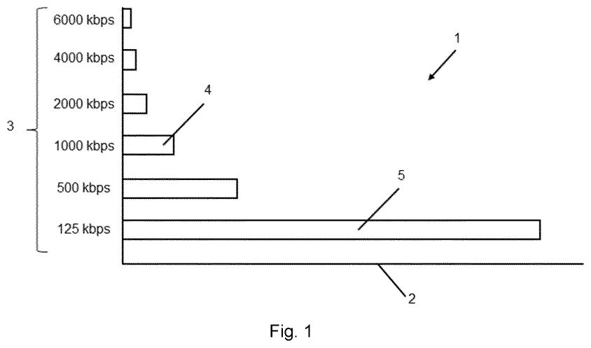

FIG. 1 discloses examples 1 of ranges obtained when using different transmission rates in a mesh communication network and, more specifically, to a Bluetooth mesh communication network.

Six different data rates 3 are plotted in FIG. 1, namely 6000 kbps, 4000 kbps, 2000 kbps, 1000 kbps, 500 kbps and 125 kbps.

The 125 kbps and 500 kbps rates are often referred to as long-range PHY. The trade-off between, on one hand, rate and time-on-air, versus on the other hand range, also applies to Bluetooth Low Energy-to maximize speed and minimize time-on-air one typically wants to use the highest data rate whenever possible.

If the Bluetooth Mesh communication network would be extended with support for the Extended Advertising feature, in the form of an Extended Advertising mesh bearer, and additional PHYs, Bluetooth Mesh networks could make use of the larger messages and all the available rates support by Extended Advertising. Utilization of low data rates, when needed, makes it possible to create links between nodes that otherwise would not be connected. Also, utilization of higher rates, when feasible, makes it possible to increase transmission rates and hence benefit from higher throughput and higher network capacity.

The inventors have found that if a mesh communication network, for example Bluetooth Mesh, is extended with support for long-range PHY and an Extended Advertising mesh bearer, one may need a mechanism that appropriately determines which rate(s) that should be utilized by the transmitting nodes in a network.

In this particular example a long-range PHY is discussed, for example using a low-rate PHY. A long-range PHY, for example using low rate, like 125 kbps, is helpful to create a link between nodes in situations with poor coverage.

The horizontal axis 2 of FIG. 1 thus describes the range of messages exchanged. A low-rate signaling may be used for extending the range, for example a rate having reference numeral 5, for connection, by a mesh node, to a mesh communication network.

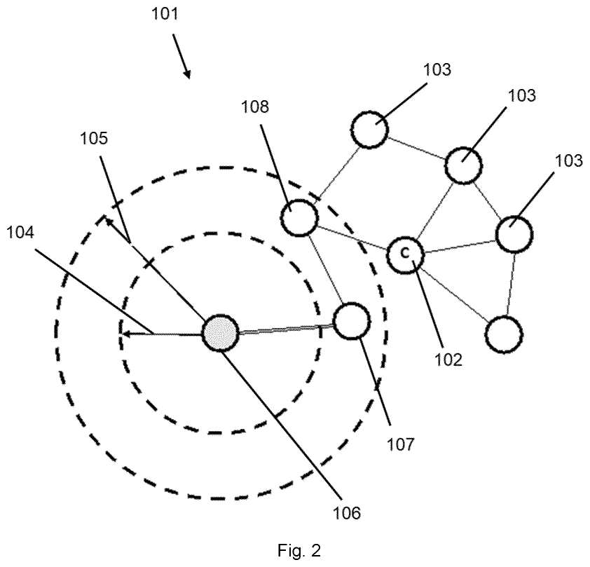

FIG. 2 discloses a schematic view 101 of a mesh node 106 that intends to connect to a mesh communication network 103, 102, 107. 108.

FIG. 2 thus depicts a situation in which there is a need for a lang-range bearer, i.e. a bearer using a long-range PHY. In FIG. 2, the mesh node having reference numeral 106 deployed in the outskirts of a mesh network is outside communication range of all other mesh nodes 103, 102, 107, 108 over a default bearer, using a default PHY, for example the default 1 Mbps bearer as shown in FIG. 1.

In this situation, the mesh node 106 does not receive any secure network beacons and does not detect any mesh network traffic, or at least any such activity is very rare and unreliable. Nor does the mesh node 106 receive any heartbeats from the controller mesh node as indicated with reference numeral 102, which is assumed to regularly publish heartbeat messages. For the disconnected mesh node 106, both the fact that no secure network beacons and no mesh traffic is detected, as well as the absence of heartbeats from the controller mesh node 102, indicate that the mesh node 106 is located out of range from other mesh node 103, 102, 107, 108.

It is noted that the default bearer range, i.e. the range associated with for example the default 1 Mbps bearer, is indicated with reference numeral 104 and the range associated with for example the long-range bearer, for example the 125 kbps bearer, is indicated with reference numeral 105.

The present disclosure is thus directed to assure that there is a possibility for the not connected mesh node 106 to obtain a connection to the mesh communication network.

The mesh communication network is illustratively indicated by the reference numerals 103, 102, 107 and 108.

The mesh communication network may be defined by interconnected mesh nodes. The controller mesh node of the mesh communication network is identified by reference numeral 102. All other mesh nodes 107, 108 and 103 of the mesh communication network are able to communicate with each other as indicated with the uninterrupted lines connecting the mesh nodes together. This thus resembles the mesh communication network.

In accordance with the present disclosure, long-range support is provided by the second mesh node 107 to the requesting mesh node 106. The second mesh node 107 is thus part of the mesh communication network as indicated with reference numerals 102, 103, 107 and 108.

The mesh node 106 is arranged to connect to a mesh communication network using a default physical layer, PHY, as indicated with reference numeral 2014 and is arranged to connect to the mesh communication network using a long-range PHY, as indicated with reference numeral 105.

FIG. 2 shows that the range of the default bearer 104 is smaller compared to the range of the long-range bearer 105.

The method comprises a first step of determining, by said mesh node, that said long-range PHY is required for connecting to said mesh communication network. Such a determination may be made, for example, by realizing by the mesh node 106 that it no longer receives heartbeat messages or the like. The mesh node 106 may expect to regularly receives messages that are being exchanged in the mesh communication network, for example heartbeats or beacons or the like. Upon no longer detecting these kinds of messages, the mesh node 106 may realize that it is no longer in range of the mesh communication network.

A next step is that the mesh node 106 broadcasts a long-range support message using said long-range PHY thereby requesting connection to said mesh communication network. This means that the mesh node 106 uses the long-range PHY, for example a low-rate message as a low-range bearer 105, for trying to connect to the mesh communication network.

In this particular case, the mesh node 106 may receive, from the mesh node 107 of the mesh communication network, a support response of said long-range support message thereby indicating support of said connection of said mesh node to said communication network using said long-range PHY.

The mesh node 107 may be considered the second mesh node in accordance with the above described aspects of the present disclosure.

It is noted that the mesh node 106 may also receive other support responses of the long-range support message from other mesh nodes in the mesh communication network. The mesh node having reference numeral 108 may also be in reach of the mesh node 106, and may thus also transmit a support response back to the mesh node 106.

The mesh node 106 may select one of the plurality of mesh nodes 107, 108, in the mesh communication network from which the mesh node 106 receives the plurality of support responses of the long-range support message, for connecting the mesh node 106 to the mesh communication network.

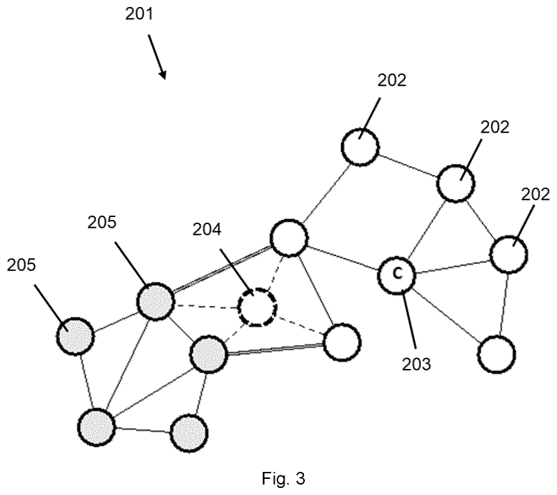

FIG. 3 discloses a schematic view 201 of a mesh communication network wherein a particular mesh node 204 is broken.

In FIG. 3, a faulty node 204 has separated a mesh network 202, 203 into two different parts, and for nodes located in the different parts it is no longer possible to communicate.

Nodes located in the upper right part of the network receive secure network beacons, detect mesh messages, and also receive regular heartbeat messages published by the control mesh node 203. Accordingly, these nodes cannot easily detect that the mesh network has been disconnected. Mesh nodes 205 in the lower left part of the mesh communication network, however, receive secure network beacons and mesh messages, but do not receive any heartbeats from the control mesh node 203. Hence, mesh nodes 205 in this part of the network may conclude that there are neighbour mesh nodes around them, but there is no path to the control mesh node 203 publishing the heartbeat messages.

The mesh node in need of a long-range bearer may be referred to as a long-range node, LRN, while a mesh node that has the capabilities to support a LRN over a long-range bearer is referred to as a long-range support node, LRSN.

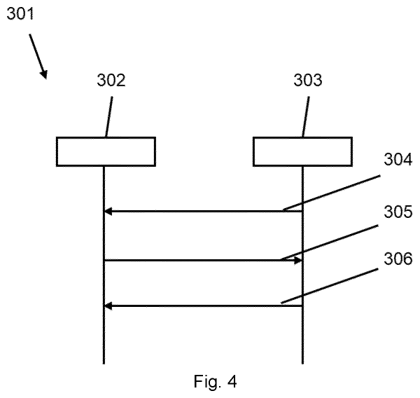

FIG. 4 provides a schematic message sequence chart that illustrates the request-support protocol. In-step 304 the LRN 303 broadcasts, to neighbour mesh nodes 302, a long-range support request message using a long-range advertising bearer. The request message may be limited to single-hop, i.e., it is not forwarded by any neighbour relay node. The request message may also contain required and optional capabilities that the LRSN should provide. For example, the LRN may ask for a specific type of bearer like advertising, connection, or similar. Furthermore, to support the situation in FIG. 3, the LRN may further require that the LRSN has a path to the control mesh node 203 publishing heartbeats, i.e., that the LRSN receives heartbeats from the control mesh node 203.

Any LRSN 302 that receives the long-range request message and has the capabilities to support the LRN responds, in step 305, by sending a support response message. The support response message can be unicasted to the LRN, and contain information about the properties and capabilities of the LRSN. As many LRSN's may respond to the same request message, the transmission scheduling of the response message is randomized in time. Relevant properties and capabilities include the resources, such as connection parameters for a GATT bearer or message storage capabilities for a Friend node, and the distance to the node sending heartbeat messages.

The LRN evaluates the different support responses received and sends, in step 306, a support response to the selected LRSN. The support response can be unicasted. The selection of LRSN is based on the information contained in the support response message, as well as local properties measured by the LRN, e.g., the RSSI of the received support message. If no support response message is received, or if no received offer is suitable, the LRN rejects all offers and no support response is transmitted. In such a case, the LRN may send another request message at a later time, perhaps with altered support requirements.

Communication in a mesh network using a long-range PHY may take several different forms, including a long-range advertising bearer, a long-range GATT bearer, and a long-range LPN-Friend relationship.

A long-range advertising bearer utilizes the Extended Advertising feature, but is otherwise comparable to the existing Bluetooth Mesh advertising bearer. Message transmitted over an advertising bearer are broadcasted, i.e., can be received by all nodes within range that belongs to the same sub-net and supports the long-range PHY. Messages sent over an advertising bearer are not acknowledged (on link layer).

Communication over a long-range PHY can also be realized over a GATT connection. Messages sent over a connection are unicasted and acknowledged.

The long-range support can also be realized in the form of an LPN-Friend node relationship, equivalent to the existing Friendship but that the communication utilizes a long-range PHY.

The present disclosure proposes a solution that facilitates utilization of long-range bearers over selected connections in a mesh communication network, without requiring manual configuration. The solution comprises a mechanism for mesh nodes to detect that long-range support is needed, followed by requesting long-range support from neighbour mesh nodes, and communication over a connection thereby connecting the requesting and the supporting mesh nodes using a long-range bearer. Optionally, the solution makes use of a central control node publishing heartbeat messages, used for analysing the mesh network connectivity.

It should be noted that the above-mentioned examples illustrate rather than limit the idea, and that those skilled in the art will be able to design many alternative examples without departing from the scope of the appended claims. The word “comprising” does not exclude the presence of elements or steps other than those listed in a claim, “a” or “an” does not exclude a plurality, and a single processor or other unit may fulfil the functions of several units recited in the claims.

Any reference signs in the claims shall not be construed so as to limit their scope.

1. A method of connecting a mesh node to a mesh communication network comprising a plurality of interconnected mesh nodes, wherein said mesh node is arranged to connect to said mesh communication network using a default physical layer (PHY) and is arranged to connect to said mesh communication network using a long-range PHY, wherein a reach area of said long-range PHY is greater than a reach area of said default PHY, said method comprises the steps of:
determining, by said mesh node, that said long-rang PHY is required for connecting to said mesh communication network;
broadcasting, by said mesh node, a long-range support message using said long-range PHY thereby requesting connection to said mesh communication network;
receiving, by said mesh node, from a second mesh node in said mesh communication network, a support response of said long-range support message thereby indicating support of said connection of said mesh node to said communication network using said long-range.

2. A method in accordance with claim 1, wherein said mesh node receives a plurality of support responses of said long-range support message from a plurality of second mesh nodes in said mesh communication network, and wherein said method further comprises the steps of:
selecting, by said mesh node, one of said plurality of second mesh nodes in said mesh communication network from which said mesh node receives said plurality of support responses of said long-range support message, for connecting said mesh node to said mesh communication network.

3. A method in accordance with claim 1, wherein messages sent using said long-range PHY have a lower rate compared to messages sent using said default PHY.

4. A method in accordance claim 1, wherein said long-range support message is sent with a lower rate compared to messages sent using said default PHY.

5. A method in accordance claim 1, wherein said step of determining comprises any of:
determining, by said mesh node, that said mesh node is out of reach of said mesh communication network by detecting absence of receipt of messages from said mesh communication network.

6. A method in accordance with claim 1, further comprising:
initiating connection establishment, by said mesh node, to said second mesh node in said mesh communication network using said long-range PHY.

7. A method in accordance with claim 1, wherein said mesh communication network is a Bluetooth Mesh communication network, and wherein said mesh nodes are Bluetooth Mesh nodes.

8. A method in accordance with claim 1, wherein said mesh node is arranged to establish a long-range bearer using said long-range PHY, wherein said long-range bearer is any of:
a connection-less advertising bearer;
a connection-oriented GATT bearer;
a connection-less advertising bearer between a low-power node and an associated friend mesh node.

9. A method of supporting connection of a mesh node to a mesh communication network comprising a plurality of interconnected mesh nodes, wherein a mesh node in said mesh communication network is arranged to connect to said mesh node using a default physical layer (PHY) and is arranged to connect to said mesh node using a long-range PHY, wherein a reach area of said long-range PHY is greater than a reach area of said default PHY, said method comprises the steps of:
receiving, from said mesh node, by said mesh node in said mesh
communication network, a long-range support message using said long-range PHY thereby requesting connection of said mesh node to said mesh communication network;
transmitting, by said mesh node in said mesh communication network,
a support response of said long-range support message thereby indicating support of said connection of said mesh node to said communication network using said long-range PHY.

10. A method in accordance with claim 9, wherein messages sent using said long-range PHY have a lower rate compared to messages sent using said default PHY.

11. A method in accordance with claim 9, wherein said long-range support message is received with a lower rate compared to messages sent using said default PHY.

12. A method in accordance with claim 9, wherein said mesh node in said mesh communication network is arranged to establish a default bearer using said default PHY, and is arranged to establish a long-range bearer using said long-range PHY, said method further comprises the step of:
establishing, by said mesh node in said mesh communication network, said long-range bearer to said mesh node using said long-range PHY.

13. A method in accordance with claim 9, wherein said mesh communication network is a Bluetooth Mesh communication network, and wherein said mesh nodes are Bluetooth Mesh nodes.

14. A method in accordance with claim 9, wherein said mesh node in said mesh communication network is arranged to establish a long-range bearer using said long-range PHY, wherein said long-range bearer is any of:
a connection-less advertising bearer;
a connection-oriented GATT bearer;
a connection-less advertising bearer between a low-power node and an associated friend mesh node.

15. A mesh node arranged to connect to a mesh communication network comprising a plurality of interconnected mesh nodes, using a default physical layer (PHY) and is arranged to connect to said mesh communication network using a long-range PHY, wherein a reach area of said long-range PHY is greater than a reach area of said default PHY, said mesh node comprising:
process equipment arranged for determining that said long-range PHY is required for connecting to said mesh communication network;
transmit equipment arranged for broadcasting a long-range support message using said long-range PHY thereby requesting connection to said mesh communication network;
receive equipment arranged for receiving from a mesh node in said mesh communication network, a support response of said long-range support message thereby indicating support of said connection of said mesh node to said communication network using said long-range PHY.

16. A mesh node in accordance with claim 15, wherein said received equipment is arranged for receiving a plurality of support responses of said long-range support message from a plurality of mesh nodes in said mesh communication network, and wherein said mesh node further comprises:
determine equipment arranged for selecting one of said plurality of mesh nodes in said mesh communication network from which said mesh node receives said plurality of support responses of said long-range support message, for connecting said mesh node to said mesh communication network.

17. A mesh node in accordance with claim 15, wherein messages sent using said long-range PHY have a lower rate compared to messages sent using said default PHY.

18. A mesh node in accordance with claim 16, wherein said process equipment is further arranged for any of:
determining that said mesh node is out of reach of said mesh communication network by detecting that no support responses are received in reply to messages sent using said default PHY;
determining that said mesh node is out of reach of said mesh communication network by detecting absence of receipt of messages from said mesh communication network.

19. A mesh node in accordance with claim 16, wherein said mesh node is arranged to establish a default bearer using said default PHY, and is arranged to establish a long-range bearer using said long-range PHY, wherein said process equipment is further arranged for:
establishing said long-range bearer to said mesh node in said mesh communication network using said long-range PHY.

20. A mesh node in accordance with claim 16, wherein said mesh communication network is a Bluetooth Mesh communication network, and wherein said mesh nodes are Bluetooth Mesh nodes.

21. A mesh node in accordance with claim 16, wherein said mesh node is arranged to establish a long-range bearer using said long-range PHY, wherein said long-range bearer is any of:
a connection-less advertising bearer;
a connection-oriented GATT bearer;
a connection-less advertising bearer between a low-power node and an associated friend mesh node.

22. A mesh node in a mesh communication network arranged for supporting connection of a mesh node to said mesh communication network comprising a plurality of interconnected mesh nodes, using a default physical layer (PHY) and is arranged to connect to said mesh node using a long-range PHY, wherein a reach area of said long-range PHY is greater than a reach area of said default PHY, said mesh node in said mesh communication network comprising:
receive equipment arranged for receiving, from said mesh node, a long-range support message using said long-range PHY thereby requesting connection of said mesh node to said mesh communication network;
transmit equipment arranged for transmitting, a support response of said long-range support message thereby indicating support of said connection of said mesh node to said communication network using said long-range PHY.

23. A mesh node in accordance with claim 22, wherein messages sent using said long-range PHY have a lower rate compared to messages sent using said default PHY.

24. A mesh node in accordance with claim 22, wherein said long-range support message is received with a lower rate compared to messages sent using said default PHY.

25. A mesh node in accordance with claim 22, wherein said mesh node in said mesh communication network is arranged to establish a default bearer using said default PHY, and is arranged to establish a long-range bearer using said long-range PHY, said mesh node further comprising:
process equipment arranged for establishing said long-range bearer to said mesh node using said long-range PHY.

26. A mesh node in accordance with any of claim 22, wherein said mesh communication network is a Bluetooth Mesh communication network, and wherein said mesh nodes are Bluetooth Mesh nodes.

27. A mesh node in accordance with claim 22, wherein said mesh node is arranged to establish a long-range bearer using said long-range PHY, wherein said long-range bearer is any of:
a connection-less advertising bearer;
a connection-oriented GATT bearer;
a connection-less advertising bearer between a low-power node and an associated friend mesh node.

28. A non-transitory computer readable medium having instructions stored thereon which, when executed by a mesh node, cause said mesh node to implement a method of connecting a mesh node to a mesh communication network comprising a plurality of interconnected mesh nodes, wherein said mesh node is arranged to connect to said mesh communication network using a default physical layer (PHY) and is arranged to connect to said mesh communication network using a long-range PHY, wherein a reach area of said long-range PHY is greater than a reach area of said default PHY, wherein said method comprises the steps of:
determining, by said mesh node, that said long-rang PHY is required for connecting to said mesh communication network;
broadcasting, by said mesh node, a long-range support message using said long-range PHY thereby requesting connection to said mesh communication network;
receiving, by said mesh node, from a second mesh node in said mesh communication network, a support response of said long-range support message thereby indicating support of said connection of said mesh node to said communication network using said long-range PHY.
